(19) United States
(12) Patent Application Publication
(10) Pub. No.: US 2006/0047554 A1
(43) Pub. Date: Mar. 2, 2006

(54) Rules based resource scheduling

(76) Inventors: Steven Larsen, Cross Plains, WI (US); Keith A. Foss, Madison, WI (US)

Correspondence Address: QUARLES & BRADY LLP, 411 E. WISCONSIN AVENUE, SUITE 2040, MILWAUKEE, WI, 53202-4497, US

(21) Appl. No.: 11/210,381

(22) Filed: Aug. 24, 2005

Related U.S. Application Data
(60) Provisional application No. 60/603,989, filed on Aug. 24, 2004.

(51) Int. Cl. G06F 9/46

(52) U.S. Cl. 705/8

(57) ABSTRACT

A method and apparatus or use with at least one resource associated with resource clients according to a schedule wherein the schedule indicates association of the resource with specific clients during time slots, the method for scheduling client association of the at least one resource and comprising the steps of specifying at least a first set of client characteristics, identifying at least a first schedule time slot during which resource association should be limited to clients having the first set of characteristics and restricting association of clients with the at least a first schedule time slot as a function of client characteristics and the first set of characteristics.

### CROSS-REFERENCE TO RELATED APPLICATIONS

This patent is related to provisional patent application No. 60/603,989 that is titled “Rules Based Resource Scheduling” and that was filed on Aug. 24, 2004.

### STATEMENT REGARDING FEDERALLY SPONSORED RESEARCH OR DEVELOPMENT

Not applicable.

### BACKGROUND OF THE INVENTION

This invention relates generally to scheduling of limited resources and more specifically to a scheduling resource or tool for use in a medical facility that suggests optimal scheduling time slots for specific appointments of patient clients or the like.

Most medical facilities now employ a scheduling employee or service (hereinafter a “scheduler”) that uses scheduling software that relies primarily on resource availability and client preferences regarding scheduling times to determine when to schedule client appointments. To this end, when a client calls to make an appointment, the scheduler collects information from the client regarding the appointment to be scheduled including client name, symptoms, concerns, preferred dates for the appointment if they exist, insurance information, prior relevant medical history, etc. Thereafter, the scheduler accesses physician schedules and schedules associated with specific or specialized medical equipment or systems (hereinafter the “specialized systems”) required to perform procedures during the appointment and attempts to locate an appropriate and available (i.e., currently unscheduled) time slot for each of a suitable physician and the required specialized systems.

In addition to indicating a physician's schedule and open and closed times on the schedule, in at least some cases, scheduling software will allow an administrator to identify specific appointment types that are to be made during specific schedule periods. For instance, one physician may only perform corrective procedures (e.g., surgery) on Tuesday and Wednesday mornings while performing diagnostic procedures at other time during the week.

Once a suitable time slot is identified that is acceptable to the client, the scheduler schedules the appointment. Hereinafter, systems that help a scheduler identify time slots when both required specialized systems and physician time are open for scheduling will be referred to as “correlating systems” or “correlating scheduling systems”.

In addition to systems that require a client to work through a scheduler associated with a medical facility, at least some systems now exist that allow a patient to use a network based (i.e., internet) software interface to check a physician's schedule and to schedule appointments directly and in person. Here, when a patient logs on to the interface, the software provides one or more scheduling screens similar to the screens used by the scheduler to schedule an appointment.

While correlating systems of the above kind have several advantages, such systems also have several shortcomings. First, as indicated above, such correlating systems are availability driven (i.e., scheduling is primarily, if not exclusively, a function of physician and system availability as well as client time slot preference and perhaps physician appointment type preference) and do not provide an effective way for other than simple physician preferences to be taken into account. To this end, for various reasons, physicians may prefer to structure their working days and weeks in different ways and hence may prefer to have factors in addition to availability applied to the appointment decision making process for their schedules. For example, where a physician maintains office hours in one part of a large medical facility that includes offices and an in-patient hospital wing, the physician may prefer to only see office clients in the morning and in-patient clients in the afternoon so that the physician does not have to travel between her office and the in-patient hospital wing between appointments.

As another example, a physician may only want to see patients that have a certain type of insurance or no insurance at all at the end of a week or during some other specific time slots reserved for such patients. As still one other example, if a specific client routinely cancels appointments at the last minutes, a physician may prefer to either have the specific client scheduled early in the morning or in the late afternoon. Many other physician preferences are contemplated.

Here, a scheduler that works at a small medical facility (e.g., a three physician medical partnership) may be able to manually keep track of a small number of simple physician preferences and take those into account when scheduling. However, in larger facilities that employ many (e.g., hundreds) physicians where each physician may have complex patient characteristic specific scheduling preferences and indeed in smaller facilities where physicians have personalized and complex scheduling preferences, schedulers cannot effectively and efficiently accommodate physician scheduling preferences in a manual fashion. Instead, in these cases, most, if not all, patient characteristic specific preferences are not even expressed much less employed to tailor physician schedules as desired.

Second, known correlating systems disadvantageously limit the number of scheduling options available for specific procedure types. In this regard, known correlating systems have limited and lacking ways to identify sub-periods of appointments during which specialized systems (e.g., equipment) are required. Because appointment sub-periods during which specialized equipment is required are unknown to the correlating scheduling system, the specialized systems have to be scheduled for an entire appointment as opposed to for sub-periods of the appointment.

For example, if a client calls to schedule a one hour chemotherapy procedure, three different specialized systems may be required to perform the procedure. A first system may be required during the first 30 minutes of the procedure, a second system may be required for 30 minutes beginning 20 minutes after the procedure is initiated and a third system may be required for 30 minutes at the end of the procedure. Here, despite the fact that each of the first, second and third systems is only required for a sub-period of the appointment, known systems do not have a way to memorialize sub-period resource requirements and therefore all of the resources have to be scheduled for the entire duration of the appointment. In the present example, the scheduler is forced to identify a time slot when all three required systems as well as a suitable physician are available for the entire appointment duration and then schedules the appointment accordingly.

In the above example it may be that during a three week period fifteen time slots occur when first, second and third systems and a suitable physician are available during temporally appropriate thirty minute sub-periods to perform the chemotherapy procedure while only three one hour appointments during the next three weeks occur when all three specialized systems and a suitable physician are available. Here, instead of fifteen scheduling options, only three options are identifiable which greatly reduces client choice.

Third, known correlating scheduling systems tie up specialized equipment or systems for full appointment durations even when the systems are only required for appointment sub-periods and therefore reduce facility profits. Historically the most expensive medical resource has been physician time and, to increase facility profitability, there has been a concerted effort to increase the number of appointments for each facility physician. For instance, in an eight hour working day, if appointment durations can be reduced from 30 minutes down to 20 minutes or from one hour down to 40 minutes, the number of appointments that a physician can attend can be increased from 16 to 24 or from 8 to 12, respectively, a 50% increase in throughput that, in theory, should translate into a 50% increase in profitability. Here, the number of physician appointments is referred to as “throughput” and the higher the throughput, the greater the resulting facility profits.

More recently, with development of complicated state of the art medical equipment and specialized systems, hourly use of many systems has become as expensive as or even more expensive than the physician time. For instance, state of the art magnetic resonance imaging (MRI) and other imaging systems have been developed that are extremely costly to procure and maintain. Here, as in the case of physicians, throughput is very important to increasing and maintaining profitability. Unfortunately, while scheduling systems have been designed to optimize physician time by reducing appointment duration, except for in the case of extremely expensive specialized medical systems (e.g., MRI, CT, PET, NMR, etc.), scheduling systems have not been similarly designed to increase throughput of most specialized medical systems and hence facility profits have not been maximized.

Therefore, it would be advantageous to have a scheduling system that could be used to memorialize many different and arbitrary physician scheduling preferences and to apply those preferences to schedules to at least suggest specific scheduling choices to schedulers. In addition, it would be advantageous to have scheduling systems that could memorialize sub-periods of specialized system use and the order of system use for at least a subset of medical procedures and that could be applied to physician/system schedules when attempting to identify time slots for specific appointment types.

### BRIEF SUMMARY OF THE INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In general, it has been recognized that it is advantageous to limit appointment times for resources as a function of characteristics of the client instead of simply as a function of availability on the resource schedule. In this manner, various factors can be taken into consideration when scheduling appointments and, in general, more optimal scheduling can be facilitated. For instance, in the case of a physician's schedule for seeing patients/clients, it has been recognized that, for various reasons, physicians may prefer to see certain types of patients at specific times of the day or on specific days of the week or month. To this end, according to at least some aspects, the present invention contemplates a system wherein preferences regarding resource characteristics (e.g., characteristics of a patient) can be codified and applied to limit or restrict access to specific schedule times and to provide guidance toward optimal schedule times. Many different additional aspects and ways of limiting access are contemplated.

Consistent with the above, at least some inventive embodiments include a method for use with at least one resource associated with resource clients according to a schedule wherein the schedule indicates association of the resource with specific clients during time slots, the method for scheduling client association of the at least one resource and comprising the steps of specifying at least a first set of client characteristics, identifying at least a first schedule time slot during which resource association should be limited to clients having the first set of characteristics and restricting association of clients with the at least a first schedule time slot as a function of client characteristics and the first set of characteristics. Here, the client set may include at least a subset of the client's gender, the client's age, payment history, appointment tardiness history, insurance coverage and in-patient/out-patient status.

at least some cases the step of restricting association of clients further includes the step of, during a scheduling procedure, identifying a client set including characteristics of a specific client for which the at least one resource is to be associated during a time slot and comparing the first set and the identified client set. Here, the step of restricting may further include, when the client set and first set are different, restricting association of the client and the at least a first time slot. In addition, in some cases the step of restricting includes preventing association of the client with the at least a first time slot. In some cases, the method is for use with a scheduling interface, the step of restricting including providing an interface, indicating via the interface that association of the client with the at least a first time slot is restricted and allowing at least one interface user having a special status to overrule the restriction and associate the client with the at least a first time slot.

In at least some cases, the method is for use with a scheduling interface, the step of restricting including indicating via the interface that association of the client with the at least a first time slot is restricted and allowing any interface user to associate the client with the at least a first time slot.

In some embodiments the method further includes including the steps of, for each of at least a subset of the schedule time slots, specifying time slot specific sets of client characteristics for restricting client association, the step of restricting association of clients further including restricting association of clients with each of the subset schedule time slots as a function of the client characteristics and the slot specific sets of characteristics. Here, the method may further include the step of, during a scheduling procedure, identifying a client set including characteristics of a specific client for which the at least one resource is to be associated during a time slot and comparing at least a subset of the slot specific sets to the identified client set. Moreover, where the method is for use with a scheduling interface, the step of restricting may include indicating at least a subset of the time slots via the interface that correspond to slot specific characteristic sets that match the identified client set for possible association with the client.

In some embodiments the step of restricting association includes restricting association in a first way, the method further including the steps of identifying at least a second schedule time slot during which resource association should be limited to clients having the first set of characteristics and restricting in a second way association of clients with the at least a second time slot as a function of client characteristics and the first set of characteristics, the second way of restricting being different than the first way of restricting. Here, the in some cases, the first way of restricting is one of prohibiting association, providing an indication of preferred prohibition while allowing association and providing an indication of prohibition while allowing certain personnel to override the prohibition and allow association and the second way of restricting is another of prohibiting association, providing an indication of preferred prohibition while allowing association and providing an indication of prohibition while allowing certain personnel to override the prohibition and allow association. In some cases the method further includes the step of, during a scheduling procedure, identifying a client set including characteristics of a specific client for which the at least one resource is to be associated during a time slot and comparing the first set and the identified client set.

In some embodiments the step of restricting further includes, when the client set and first set match, restricting association of the client and the first and second time slots in the first and second ways, respectively. In some cases the method is for use with a scheduling interface, the step of restricting including, when at least one of the first and second time slots is accessed via the interface, indicating via the interface the way that the accessed time slot is restricted. In at least some cases the interface includes a time and day chart and indicates differently restricted time slots with different colors.

In some embodiments the method further includes the steps of identifying at least a third schedule time slot during which resource association should be limited to clients having the first set of characteristics and restricting in a third way association of clients with the at least a third time slot as a function of client characteristics and the first set of characteristics, the third way of restricting being different than the first and second ways of restricting.

In still other cases at least some of the time slots are unrestricted such that a client having the first set of characteristics can be associated therewith. In some cases the methods is for use with a scheduling interface wherein the step of restricting association of clients further includes the steps of, during a scheduling procedure, identifying a client set including characteristics of a specific client for which the at least one resource is to be associated during a time slot, identifying time slots that are unrestricted such that a client having the first set of characteristics can be associated therewith and presenting at least a subset of the identified time slots via the interface for association with the patient.

In yet other embodiments the step of specifying at least a first set of client characteristics includes specifying at least first and second characteristics wherein the first characteristic is a required characteristic and the second characteristic is a preferred characteristic. Here, the step of restricting may include, during a scheduling procedure, identifying a client set including characteristics of a specific client for which the at least one resource is to be associated during a time slot and comparing the first set and the identified client set, when the client set includes the first characteristic and the second characteristic, allowing association of the client and the corresponding time slot, when the client set includes only the first of the two characteristics, restricting association in a first way and when the first characteristic is missing from the first client set, restricting association in a second way that is different than the first way. Furthermore, in some cases, the method further includes the step of providing an interface and indicating possible time slots for association with a client along with, for time slots where association is restricted, the way in which association is restricted. Moreover, in some cases the step of indicating the way in which association is restricted includes presenting a time chart where differently restricted time slots are presented via different colors.

In some cases the method further includes the step of identifying a commencement period between a current time and each schedule time slot, the step of restricting association further including restricting association of clients with the at least a first schedule time slot as a function of client characteristics, the first set of characteristics and the commencement period corresponding to the at least a first schedule time slot.

In some cases the step of identifying at least a first schedule time slot during which resource association should be limited to clients having the first set of characteristics includes identifying a plurality of time slots during which resource association should be limited to clients having the first set of characteristics, the step of restricting including, when the client and first set match, scheduling the specific client for association during the one of the identified plurality of time slots. Here, the step of scheduling the specific client may include indicating at least a subset of the identified plurality of time slots via the interface and allowing selection of at least one of the indicated time slots via the interface.

According to another aspect, at least some embodiments include a method for use with at least one resource associated with resource clients according to a schedule wherein the schedule indicates association of the resource with specific clients during time slots, the method for scheduling client association of the at least one resource and comprising the steps of obtaining a client characteristic set including characteristics of a specific client and restricting association of the specific client with at least a first schedule time slot as a function of the client characteristics.

Here, the step of restricting may include specifying a first characteristic set including client characteristics corresponding to a clients that may be associated with at least the first time slot, comparing the client set to the first set, when the first set and client set match, allowing association and when the first set and client set are different, at least limiting association. Moreover, the step of limiting association includes, in at least some cases, one of prohibiting association, providing an indication of preferred prohibition while allowing association and providing an indication of prohibition while allowing certain personnel to override the prohibition and allow association.

According to another aspect, at least some embodiments include a method for use with at least one resource associated with resource clients according to a schedule wherein the schedule indicates association of the resource with specific clients during time slots, the method for scheduling client association of the at least one resource and comprising the steps of specifying at least a first set of client characteristics including at least first and second characteristics wherein the first characteristic is a required characteristic and the second characteristic is preferred characteristic, identifying at least a first schedule time slot during which resource association should be limited to clients having the first set of characteristics, identifying a client characteristic set corresponding to a specific client and restricting association of the specific client with the at least a first schedule time slot as a function of client characteristic set and the first set of characteristics.

Other inventive embodiments include a method for use with at least one resource associated with resource clients according to a schedule wherein the schedule indicates association of the resource with specific clients during time slots, the method for scheduling client association of the at least one resource and comprising the steps of specifying at least a first set of client characteristics, identifying at least a first schedule time slot during which resource association should be limited to clients having the first set of characteristics, identifying an intervening period between a current time and the at least a first schedule time slot identifying a client characteristic set corresponding to a specific client and restricting association of the specific client with the at least a first schedule time slot as a function of client characteristic set, the first set of characteristics and the intervening period.

Still other embodiments include a method for use with at least one resource associated with resource clients according to a schedule wherein the schedule indicates association of the resource with specific clients during time slots, the method for scheduling client association of the at least one resource and comprising the steps of specifying at least a first set of client characteristics, identifying at least a first schedule time slot during which resource association should be restricted in a first way to clients having the first set of characteristics, identifying at least a second schedule time slot during which resource association should be restricted in a second way to clients having the first set of characteristics, identifying a client characteristic set corresponding to a specific client and restricting association of the specific client with the at least first and second schedule time slots as a function of the client characteristic set and the first and second ways of restricting, respectively.

Other embodiments include a method for use with at least one resource associated with resource clients according to a schedule wherein the schedule indicates association of the resource with specific clients during time slots, the method for scheduling client association of the at least one resource and comprising the steps of specifying a plurality of specified sets of client characteristics, for at least a subset of the specified sets, identifying a plurality of schedule time slots during which resource association should be limited to clients having the specified set of characteristics, identifying a client characteristic set corresponding to a specific client and comparing the client characteristics to the specified sets of characteristics and limiting association of the specific client with the schedule time slots as a function of the results of the comparison.

Still other embodiments include a method for use with at least first and second resources required to perform at least one specific procedure during a time slot that includes at least a first sub-period and a second sub-period wherein at least a portion of the second sub-period includes time independent of the first sub-period and the first and second resources are required during the first sub-period and a second sub-period, respectively, the method also for use with a schedule wherein the schedule indicates association of the first and second resources with sub-periods of time slots corresponding to instances of procedures, the method for scheduling first and second resource use and comprising the steps of specifying information associated with the at least one specific procedure including required resources and the durations of the first and second sub-periods, identifying at least a subset of schedule time slots where the first and second resources are unscheduled for first and second sub-periods of each of the subset time slots and presenting the identified subset of schedule time slots.

Yet other embodiments include a method for use with a plurality of resources required during different sub-periods to perform at least one specific procedure during a time slot, the method also for use with a schedule wherein the schedule indicates association of the resources with sub-periods of the time slots corresponding to instances of the procedure, the method for scheduling use of the plurality of resources and comprising the steps of for the at least one specific procedure, providing resource requirement information that specifies required resources and the durations and relative timings of the sub-periods associated with the resources, identifying at least a subset of schedule time slots during which the required resources are unscheduled for sub-periods of each of the subset time slots specified by the resource requirement information and presenting the identified subset of schedule time slots.

Apparatus are also contemplated for performing the methods described above and in this specification generally wherein an exemplary apparatus includes a processor for performing the methods, a database for storing data and programs required by the processor, an interface/input device and a display/output device. Networked apparatus and components are also contemplated.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE SEVERAL VIEWS OF THE DRAWINGS

The invention will hereafter be described with reference to the accompanying drawings, wherein like reference numerals denote like elements, and:

FIG. 1 is a schematic diagram of a scheduling system used to implement various aspects of the present invention;

FIG. 2 is a doctor's schedule window that may be presented via the interface of FIG. 1 illustrating a schedule corresponding to a specific doctor that works at a medical facility associated with the system of FIG. 1;

FIG. 3 is a simplified and exemplary scheduling window that may be provided via the interface of FIG. 1;

FIG. 4 is a physician preferences database that associates scheduled time slots with block types where the block types are associated with specific physician preferences for scheduling purposes;

FIG. 5 is a schematic diagram of a block type definition database that defines various block types used to populate the schedule of FIG. 4;

FIG. 6 is a flow chart illustrating one method according to certain aspects of the present invention wherein client/appointment characteristics are compared to physician preferences in the preferences database and a warning regarding physician preferences is provided when required;

FIG. 7 is an exemplary warning window that may be provided via interface 14 in FIG. 1 where, in addition to indicating a physician preference, appropriate time slots for a specified appointment are suggested as well as selection tools;

FIG. 8 is a sub-method that may be substituted for a portion of the method of FIG. 6 wherein preference bypass is facilitated;

FIG. 9 is a warning window that may be provided via the interface of FIG. 1 when a warning message is generated via the sub-method of FIG. 8;

FIG. 10 is a sub-method that may be substituted for a portion of the method of FIG. 6 wherein restricted preference bypass is facilitated;

FIG. 11 is a warning window that may be provided via the interface of FIG. 1 according to at least some aspects of the present invention;

FIG. 12 is a preferred time slot search window that may be provided via the interface of FIG. 1 according to at least some aspects of the present invention;

FIG. 13 is a window suggesting time slots for scheduling specified appointment according to at least some aspects of the present invention;

FIG. 14 is an exemplary procedure resource database that specifies resources and sub-periods of procedure periods during which the resources are required to facilitate each of the procedures;

FIG. 15 is an exemplary resource schedule database that may be used with the system of FIG. 1;

FIG. 16 is a flow chart that illustrates a resource scheduling method according to at least some aspects of the present invention;

FIG. 17 is a window that suggests time slots for scheduling an appointment according to at least some aspects of the present invention; and

FIG. 18 is an exemplary resource schedule database that may be used with the system of FIG. 1.

### DETAILED DESCRIPTION OF THE INVENTION

One or more specific embodiments of the present invention will be described hereinafter. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Hereinafter, aspects of the present invention will be described in the context of a simplified scheduling system that keeps track of physician schedules for physicians that work at an exemplary medical facility and schedules of medical equipment/systems used at the facility in order to simplify this explanation. Nevertheless, it should be appreciated that the inventive aspects are also intended to be used with more complex scheduling systems. For example, while the inventions are described herein in the context of the system including a single scheduling server, it is contemplated that more than one server may maintain physician schedules and may be linked via the internet or the like. Similarly, while the information system is described in the context of a single medical facility, it should be appreciated that the system may be employed where a plurality of related medical facilities cooperate to provide services and where scheduling functions are provided across related facilities. As another example, while the simplified system is described as including a single scheduling interface, it should be appreciated that many different interfaces may be employed for scheduling purposes.

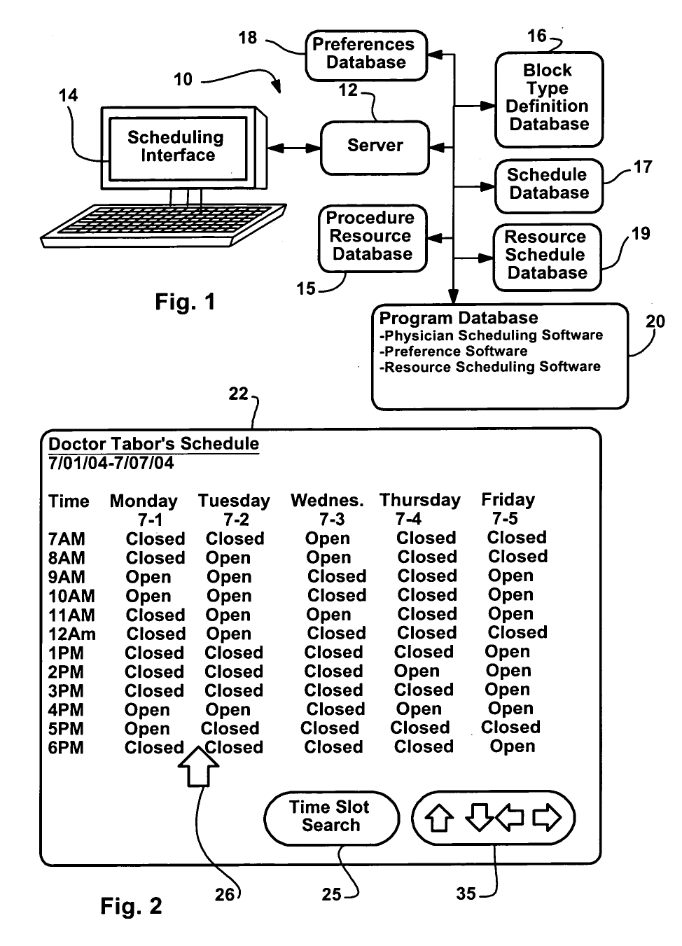

Referring now to the drawings wherein like reference numerals correspond to similar elements through the several views and, more specifically, referring to FIG. 1, the inventions will be described in the context of an exemplary scheduling system 10 including a server 12, a scheduling interface 14, a block type definition database 16, a schedule database 17, a preferences database 18, a program database 20, a resource schedule database 19 and a procedure resource database 15. Server 12 includes one or more high speed processors that run various programs to carry out methods that are consistent with the present invention. To this end, server 12 is linked via a computer network represented by lines in FIG. 1 to scheduling interface 14 and each of databases 15, 16, 17, 18, 19 and 20. The programs run by server 12 are stored in program database 20 and include, among others, scheduling software, physician preference software and resource scheduling software.

As the label implies, physician scheduling software is run by server 12 to maintain schedules for physicians that work at a medical facility associated with system 10. To this end, the scheduling software keeps track of a calendar for each one of the facility physicians and allows a scheduler (i.e., a facility employee charged with maintaining the physician's schedules) to modify the schedule thereby adding appointments to the schedule and removing appointments from the schedule when appropriate.

Referring also to FIG. 2, an exemplary schedule window 22 that may be provided via interface 14 by server 12 running the scheduling software illustrates a five day schedule for one of the facility physicians, Dr. Tabor. Exemplary window 22 identifies Dr. Tabor at the top of the window and includes a table including six columns and a plurality of rows. The first column of the table is a time column which divides the time in a working day into one hour time slots including 7 AM, 8 AM, 9 AM, etc. Each of the second through sixth columns in the table is a working day of the week column. Thus, for instance, the second column in the table corresponds to Monday, the third column corresponds to Tuesday, etc.

The Monday column includes a status designation for each time slot in the time column where the status designations indicate either “OPEN” or “CLOSED”. And OPEN status designation indicates that the time slot is open for Dr. Tabor and that an appointment may be scheduled in that time slot. A CLOSED status designation indicates that Dr. Tabor is not free to conduct an appointment during the associated time slot either because the doctor already has an appointment scheduled or because the doctor is not taking an appointment during that time. Similarly, status designations are provided in each of the other day columns (i.e., the third through sixth columns of the table) for each of the time slots in the first column of the table.

In addition to the doctor designation in the table described above, window 22 includes various interfacing or input tools that can be used by the scheduler to perform scheduling functions. To this end, a mouse controlled arrow or pointing cursor 26 (hereinafter “cursor”) is illustrated which can be used (i.e., moved over an icon to select while a controlling mouse is double-clicked) to select one of the status designations in the table to either receive additional information about a closed time slot or to select one of the open time slots for scheduling an appointment. In addition, a multifunction scrolling icon 35 is provided that allows the scheduler to scroll through other days, weeks, months and hours of Dr. Tabor's schedule. Other tools for scrolling through physician's schedules or for searching for specific information in physician schedules are contemplated and are not described here in the interest of simplifying this explanation. An abbreviated list of other possible interface tools include voice command receiving hardware, track balls, key boards, pen or stylus type input devices, touch screens for selecting on screen icons, etc.

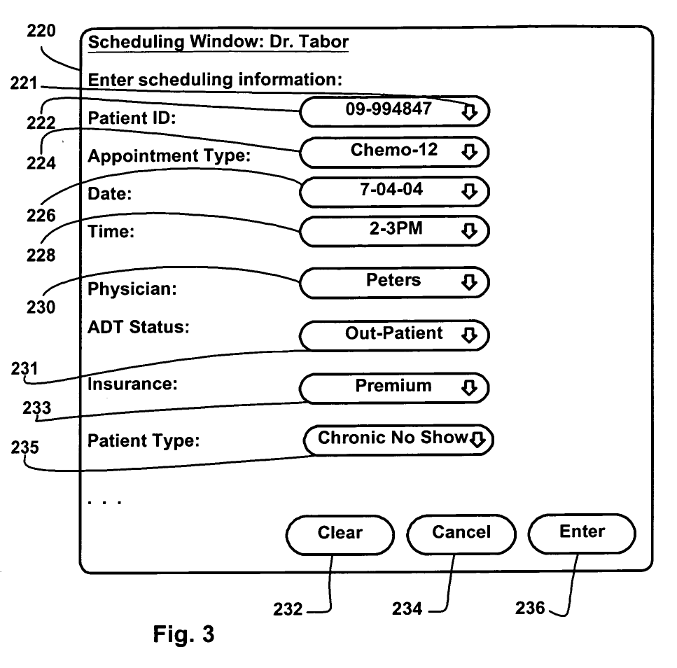

Referring still to FIG. 2, to schedule an appointment with Dr. Tabor on Thursday, July 4, in the 2 PM time slot, a scheduler uses cursor 26 to select the “OPEN” status designation corresponding to the 2 PM time slot on Thursday, July 4. When the “OPEN” designation is selected, referring to FIG. 3, a scheduling window 220 is opened.

The exemplary scheduling window 220 indicates at the top that the window corresponds to Dr. Tabor and includes a plurality of appointments specifying fields that can be filled in by the scheduler to schedule an appointment for Dr. Tabor. In this regard, the exemplary scheduling widow 220 includes a patient ID field 222, an appointment type field 224, a date field 226, a time or time slot field 228, a physician field 230, an admit, discharge, transfer (ADT) field 231, an insurance field 233 and a patient type field 235. Here, information from the previous schedule windows (see again FIG. 2) can be used to automatically populate at least some of the scheduling fields. For example, because the scheduler selected the 2 PM time slot on Thursday, July 4, the date and time fields 226 and 228, respectively, can automatically be filled in. In addition, physician field 230 can automatically be filled in as the scheduling screen window 224 corresponds to Dr. Tabor. The scheduler fills in the remaining specifying fields with appointment specifying information. In the present example, the scheduler fills in the patient ID number 09-994847 in patient ID field 222 and a “chemo-12” activity in appointment type field 224, “out-patient” in the ADT status field 231, “Premium” in insurance field 233 and “Chronic No-Show” in patient type field 235. To aid the scheduler in filling in the fields, server 12 may provide drop down menus of pre-canned designations suitable for each field. In FIG. 3, each field includes a pull down menu icon (see, e.g., 221) which when selected via cursor 26, presents the pre-canned options.

In addition to filling in at least some of the fields automatically with information from the prior window (see FIG. 2), in at least some cases server 12 may be programmed to access other data corresponding to a specific patient that is stored elsewhere in databases linked to server 12. For instance, once a patient ID is specified in field 222, server 12 may automatically access an insurance database to determine insurance type (e.g., Premium, Medicare, Compcare, etc.) and may then fill in insurance field 233 with a default designation. Similarly, patient type field 235 and others may be filled in automatically.

Here, the phrase “patient type” is used to refer to a general category of patient that is related to prior patient activity and, more specifically, to the likelihood that a patient will attend and be on time for appointments based on prior experience with the patient. For instance, a patient that never misses an appointment and that is always on time may be designated as a “perfect attendee” while a patient that has canceled the last three appointments may be labeled a “chronic no-show”. Other designations are contemplated.

In addition to the physician designation and specifying fields, cursor selectable CLEAR, CANCEL and ENTER icons 232, 234 and 236, respectively, are provided near the bottom of window 220. CLEAR icon 232 can be used to clear all of the information in the specifying fields above. CANCEL icon 234 can be used to cancel the current scheduling activity and return to the previous schedule window (e.g., see again FIG. 2). ENTER icon 236 is selectable to schedule an appointment consistent with the information specified in the fields of window 220.

Referring again to FIG. 1, in at least some embodiments of the present invention, the physician preference software, as the label implies, compares client or appointment characteristics for a potential client or appointment as specified by a scheduling screen (see again FIG. 3) or the like to physician preferences associated with specific scheduled time slots and then either allows an appointment to be scheduled or performs some restricting procedure to restrict or limit scheduling of the appointment. For example, in at least some embodiments of the present invention, if a scheduler specifies a potential appointment time for an out patient appointment when a physician prefers only in-patient appointments, server 12 may generate a warning indicating the doctor's preference for in-patient appointments only during the specified time slot. As another example, the scheduler may select a time slot for an appointment for a patient that is a chronic no-show type patient during which the doctor prefers to see only reliable patients. In either of the two above cases, server 12 may be programmed to do any of several different things in conjunction with the warning. For instance, while providing a warning, server 12 may allow the scheduler to by-pass the doctor's preference and schedule an appointment anyway. As another instance, server 12 may allow only specific schedulers to bypass doctor preferences. To this end, server 12 may require a bypass password or the like to be entered by the scheduler prior to bypassing the preferences where suitable passwords are only known to schedulers having the authority to bypass preferences. In some cases while a first scheduler may be authorized to bypass all preferences, a second scheduler may only be authorized to bypass a subset of preferences when an associated password is entered and a third scheduler may not be authorized to bypass any of the preferences. In some embodiments, instead of requiring password entry after a warning window is provided to bypass, schedulers may be required to log onto interface (e.g., 14) prior to performing scheduling functions and that log on procedure may set bypass capabilities for the interface until the scheduler logs off. Hereinafter when a scheduler has to perform any type of security function such as entering a password or the like to bypass physician preferences, the process will be referred to as a “restricted bypass process”. As one other instance, server 12 may rigidly enforce doctor preferences and not allow a scheduler to bypass the preferences.

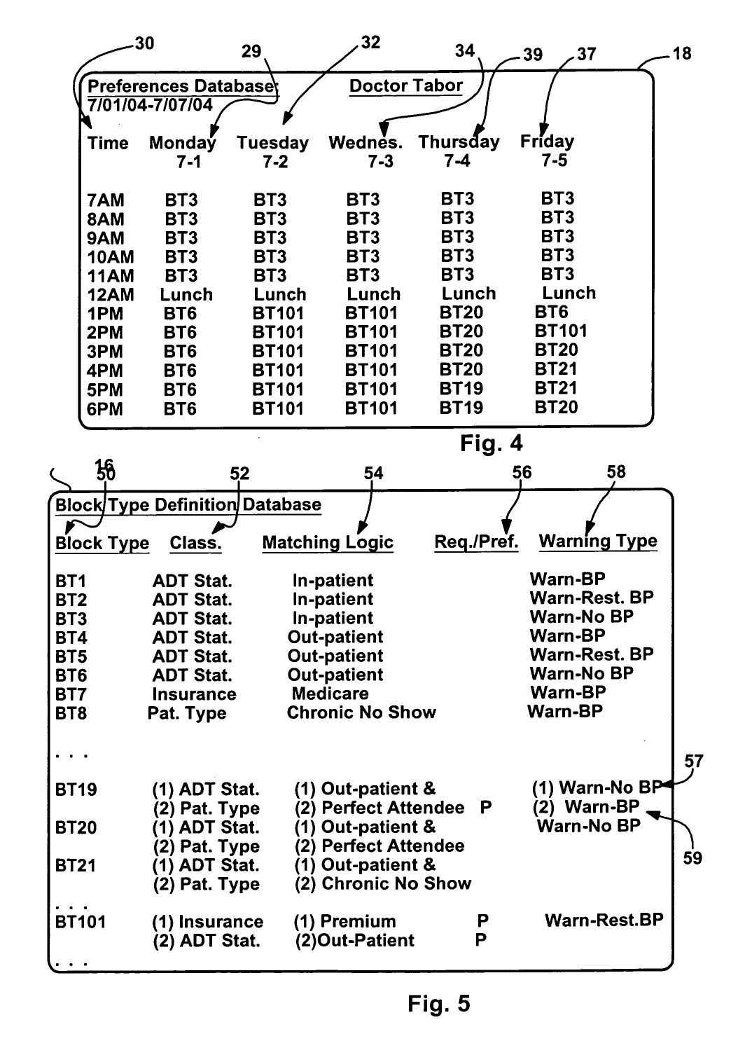

Referring still to FIG. 1 and also to FIG. 4, an exemplary preference database 18 corresponding to Dr. Tabor includes six separate columns including a time column 30 and Monday through Friday day columns 29, 32, 34, 39 and 37, respectively. Time column 30 divides the time in a working day into one hour time slots including 7 AM, 8 AM, 9 AM, etc. Each of the day columns 29, 32, 34, 39 and 37 corresponds to a working day of a single week and includes a separate block type designation for each of the time slots in time column 30. Exemplary block type designations are identified by labels including a “BT” followed by a distinguishing number (e.g., 3, 6, 101, 20, etc.) that distinguishes one block type from the others. Thus, for example, for the time slot corresponding to Monday, July 1 between 7 AM and 8 AM, Dr. Tabor's preferences database specifies a block type BT3, for the time slot between 1 and 2 PM on Monday, July 1, the preferences database specifies a block type BT6, for the time slot between 5 and 6 PM on Wednesday, July 3, the preferences database specifies a block type BT101, etc.

Referring now to FIG. 5, an exemplary block type definition database 16 is illustrated which specifies characteristics of a large number of different block types that may be used to instantiate physician schedules as illustrated in FIG. 4. To this end, block type database 16 includes a block type column 50, a classification column 52, a matching logic column 54, a required/preferred column 56 and a warning type column 58. Block type column 50 lists each of the separate block types supported by server 12. For example, exemplary block types in column 50 include types labeled BT1, BT2, BT3, . . . BT20, BT21, . . . BT101, etc.

Classification column 52 indicates at least one general class of block type for each one of the block types in column 50 where, in the present example, the general classes correspond to the fields filled in via a scheduling window (see again FIG. 3). For example, each of block types BT1 and BT2 has an ADT status classification corresponding to field 231 in FIG. 3, block type BT7 has an insurance classification that corresponds to field 233 in FIG. 3, and block BT8 has a patient type classification that corresponds to field 235 in FIG. 3.

In at least some embodiments at least a subset of block types will be associated with two or more classifications in column 52 which means that, for any time slot associated with the block type, two or more preferences, one preference for each class, have been specified. For instance, a physician may prefer an out-patient appointment (i.e., a first preference) with a patient having premium insurance (i.e., a second preference) for a specific time slot. Consistent with this example, block type BT101 is associated with both an ADT status classification and an insurance classification in column 52.

Matching logic column 54 includes one appointment or client characteristic for each of the classifications in column 52. For example, column 54 includes an in-patient characteristic for the AST status classification associated with block type BT1, an out-patient characteristic for the ADT status classification associated with block type BT4, a chronic no-show characteristic for the patient type classification associated with block type BT8, and so on. For each block type associated with two or more classifications, a separate matching logic characteristic is specified in column 54 for each of the classifications in column 52. For instance, “premium” and “out-patient” characteristics are listed in column 54 for the insurance and ADT status classifications in column 52 that are associated with block type BT101 in column 50. As another instance “out-patient” and “perfect attendee” characteristics are listed in column 54 for the ADT status classifications in column 52 that are associated with block type BT19 in column 50.

In at least some cases, the matching logic characteristics may be identical for two or more different block types in column 50. For example, the in-patient characteristic in column 54 is common to each of block types BT1, BT2 and BT3. The block types BT1, BT2 and BT3 are different only in the warning type associated with each one those block types as specified in column 58 to be described below.

Required/preferred column 56 includes “P” designations for some of the characteristics in column 54. More specifically, in cases where two or more characteristics are specified in column 54 for a single block type in column 50, a P designation indicates a preferred as opposed to a required characteristic. For example, a preferred designation P is associated with the perfect attendee characteristic in column 54 corresponding to block type BT19 in column 50. Similarly, preferred designations P are provided in column 56 for each of the premium insurance and out-patient characteristics in column 54 corresponding to block type BT101 in column 50. In the present example, where two or more characteristics in column 54 are associated with one of the block types in column 50, for any of the multiple characteristics in column 54 that are not associated with a preferred designation P in column 56, it is assumed that the characteristic is required as opposed to being preferred. Thus, for instance, the out-patient characteristic in column 54 corresponding to block type BT19 in column 50 is required instead of being preferred, each of the out-patient and perfect attendee characteristics in column 54 corresponding to block type BT20 in column 50 is required, etc.

As the labels imply, a preferred designation P simply means that if an associated block type is specified in a time slot in a doctor's schedule, the doctor prefers a client or appointment having the related characteristic while required characteristics are characteristics that the doctor requires of a client or appointment during a time slot associated with the specific block type. For instance, for the time slots corresponding to block type BT19, database 16 and, more specifically, column 54, specifies that a doctor requires an out-patient appointment and prefers a perfect attendee while for time slots associated with block type BT20, the doctor requires both an out-patient and a perfect attendee. As another example, for time slot associated with block type BT101, the doctor does not require but simply prefers a client having premium insurance and an out-patient appointment.

Referring still to FIG. 5, warning type column 58 includes at least one warning type for each one of the block types in column 50. The exemplary embodiment contemplates three different types of warnings including “Warn-BP”, “Warn-Rest. BP” and “Warn-NO BP” types. The Warn-BP type indicates that a physician preference warning is to be given when appointment characteristics do not match the matching logic characteristics corresponding to a block type associated with a time slot during which a scheduler is attempting to schedule an appointment and that the warning can be bypassed by any scheduler to disregard a physician's preference. For example, where a scheduler attempts to schedule an out-patient appointment during a scheduled time slot associated with a block type BT1 that is associated with an in-patient matching logic characteristic in column 54, the Warn-BP designation column 58 causes server 12 to generate a warning including input tools to bypass the warning and the preferences if the scheduler decides to schedule an appointment in spite of the preferences.

A Warn-Rest. BP type warning in column 58 is similar to a warn-BP type warning except that only certain schedulers are allowed to bypass physician preferences, typically by entering a special password indicating the schedulers authority to bypass. Thus, for instance, the warn-Rest. BP type warning in column 58 associated with block type BT2 in column 50 causes server 12 to generate a warning when a scheduler attempts to schedule an out-patient appointment during a time slot associated with block type BT2 where the warning includes input tools that allow the scheduler to bypass the warning in a restricted fashion if the scheduler decides to schedule an appointment in spite of the preferences.

A warn-NO BP designation in column 58 causes server 12 to provide a warning when characteristics of an appointment being scheduled by a scheduler or characteristics of a client for which an appointment is being scheduled do not match the matching logic characteristic or characteristics in column 54. For instance, if a scheduler attempts to schedule an out-patient appointment during a time slot associated with block type BT3, pursuant to the warning type in column 58 associated with type BT3, server 12 provides a warning that the appointment cannot be made during the designated time slot and that the doctor's preference cannot be bypassed.

In cases where two or more matching logic characteristics in column 54 are associated with a single block type in column 50 and at least one of the characteristics is preferred While at least one of the characteristics is required as indicated by the designation in column 56, more than one warning type may be associated with the matching characteristic set, the warning type being used depending upon which sub-set of logic characteristics specified in column 54 are different than specified appointment/client characteristics. For instance, referring again to block type BT19 that is associated with a required out-patient characteristic and a preferred perfect attendee characteristic in column 54, when specified appointment/client characteristics specify an in-patient appointment and therefore the out-patient characteristic is not met, because the out-patient characteristic is required, a warning that does not allow by-pass must be generated (see Warn-NO BP 57 in FIG. 5). However, if the specified appointment/client characteristics specify an out-patient appointment and a chronic no-show patient type, because the perfect attendee characteristic is only preferred (i.e., is not required), a warning including bypass tools may be generated (see Warn-BP 59 in FIG. 5). Where all characteristics in a matching logic characteristic set are preferred or all are required, if any of the characteristics in the set are missing from specified appointment/client characteristics, a single type of warning may be provided (e.g., a Warn-BP type for sets including all preferred characteristics and a Warn-NO BP type for sets including all required characteristics).

Referring again to FIGS. 4 and 5, it can be seen that all of the morning time slots for Dr. Tabor during the portion of Dr. Tabor's preference schedule illustrated are associated with block type BT3 meaning that Dr. Tabor requires in-patient appointments during those time slots. The warning type in column 58 corresponding to block type BT3 indicates that, if a scheduler attempts to schedule an out-patient appointment during any of the morning time slots between July 1 and July 5 for Dr. Tabor, a warning will be presented which indicates Dr. Tabor's preference for in-patient appointments and indicates that the preference cannot be bypassed.

During the afternoon time slots on Monday, July 1, database 18 indicates that each of the afternoon time slots is associated with a block type BT6. In FIG. 5, block type BT6 is associated with an out-patient characteristic and the warning type in column 58 indicates that, if a scheduler attempts to schedule an in-patient appointment with Dr. Tabor during any of the afternoon time slots on July 1, server 12 will provide a warning indicating Dr. Tabor's preference for out-patient appointments and also indicating that the preference cannot be bypassed.

Referring still to FIGS. 4 and 5, the afternoon time slots on July 2 and July 3 are each associated with block type BT101. Block type BT101 is associated with two characteristics in column 54, a premium insurance characteristic and an out-patient characteristic. Column 56 indicates that each of the two characteristics in column 54 are only preferred and that neither is required. The restricted warning type in column 58 indicates that the doctor's preferences as specified in column 54 can be bypassed by certain schedulers having authority to bypass. Thus, during the afternoon time slots on July 2 or July 3, if a scheduler attempts to schedule an in-patient appointment and/or an appointment with a client that does not have premium insurance, pursuant to the warning type in column 58 associated with block type BT101, server 12 provides a warning that can be bypassed in a restricted fashion (e.g., via entry of an appropriate password).

Referring once again to FIGS. 4 and 5, the first four time slots on the afternoon of July 4 are associated with block type BT20 where column 54 and column 56 in database 16 indicate that Dr. Tabor requires both out-patient appointments and a perfect attendee and column 58 indicates that if the characteristics in column 54 are not met, server 12 provides a warning indicating the doctor's preferences and that the preferences cannot be bypassed. The last two time slots on the afternoon of July 4 are associated with block type BT19 where columns 54 and 56 indicate that Dr. Tabor requires out-patient appointments and only prefers perfect attendees. Here, if a scheduler attempts to schedule an in-patient appointment, column 58 indicates that server 12 will provide a warning and indicate that the doctor's preference for out-patient appointments during the selected time slot cannot be bypassed. If a scheduler attempts to schedule an out-patient appointment for a client that is not a perfect attendee during one of the last two time slots on July 4, column 58 indicates that server 12 will provide a warning that the doctor prefers perfect attendees during the time slot but that also allows the scheduler to bypass the doctor's preference for perfect attendees.

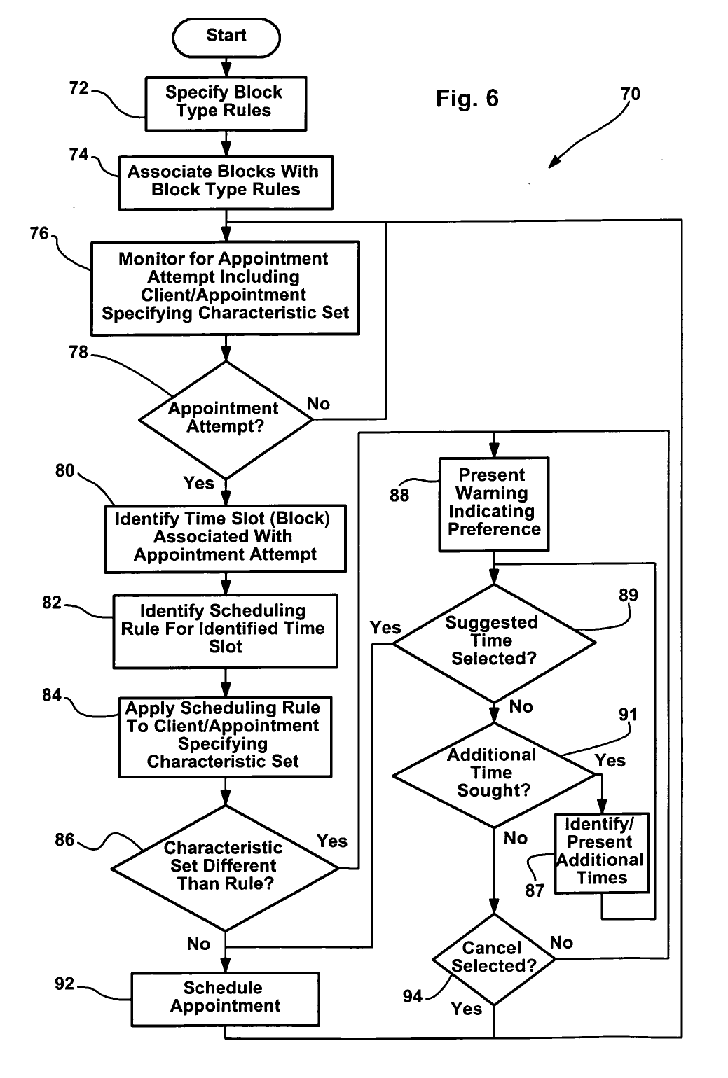

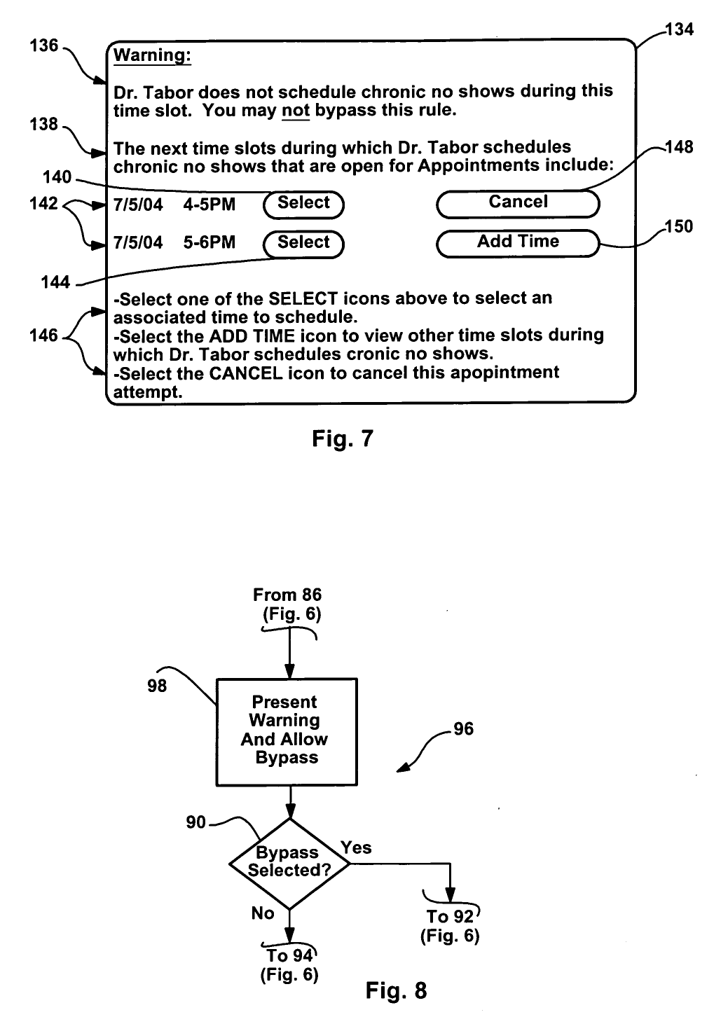

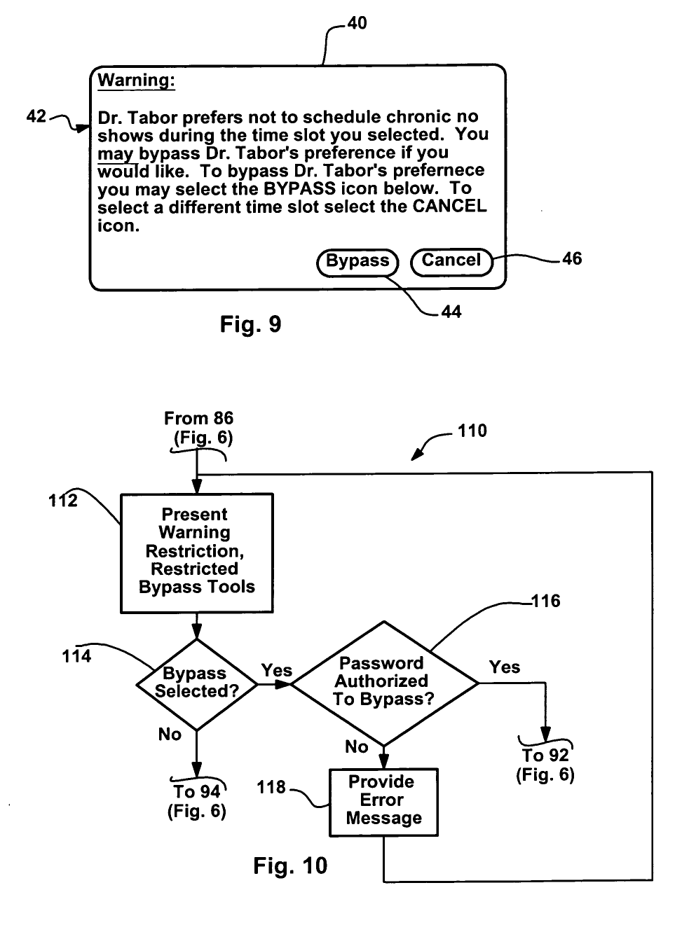

Referring now to FIG. 6, an exemplary method 70 according to at least some aspects of the present invention is illustrated. Referring also to FIG. 5, at block 72, block type definitions or rules are defined that comprise the block type database 16. At block 74, referring also to FIG. 4, specific schedule time slots are associated with specific block type that were specified at block 72. Here, while not illustrated, server 12 may provide windows or screenshots via interface 14 enabling a scheduler to memorialize preferences for specific facility doctors like Dr. Tabor where software walks the scheduler through various questions required to associate block types with time slots. In any event, after block 74 in FIG. 6, a preference databases similar to database 18 is specified and stored for each facility physician.

Referring still to FIG. 6, at block 76, server 12 monitors interface 14 to identify when a scheduler attempts to make an appointment including client/appointment specifying characteristics. To this end, referring again to FIG. 3, after all of the specifying fields presented via window 220 have been filled in with appropriate information, when a scheduler selects ENTER icon 236, an appointment attempt is made. At block 78, where no appointment attempt has been made, control loops back up to block 76.

When an appointment attempt is made, control passes down to block 80 where server 12 identifies the time slot associated with the appointment attempt. In the example illustrated in FIG. 3, the time slot is the 2 PM time slot on Jul. 4, 2004. At block 82, server 12 identifies the scheduling rule associated with the specified time slot. Here, the scheduling rule is identified by identifying the block type associated with the specified time slot and then accessing block type database 16 (see again FIG. 5) to identify the matching logic characteristics in column 54. In the present example, where the specified time slot is the one hour 2 PM time slot on July 4 for Dr. Tabor, referring to FIG. 4, the block type is BT20. Referring to FIG. 5, the matching logic characteristics in column 54 associated with block type BT20 in column 50 require an out-patient appointment and a prefect attendee.

At block 84, server 12 compares the characteristics associated with the block type to the attempted appointment characteristics. At block 86, where the attempted appointment characteristics match the matching logic characteristics for the time slot, control passes to block 92 where server 12 schedules the appointment. However, where the attempted appointment characteristics are different than the matching logic characteristics for the time slot, control passes up to block 88 where server 12 presents a physician preference warning.

In the present example, referring again to FIG. 3 where the ADT status is out-patient and the patient type is “chronic no-show”, at block 86 in FIG. 6, the attempted appointment characteristics are different than the matching logic characteristics associated with block type BT20 in FIG. 5. Thus, control passes from block 86 to block 88. Consistent with the warning type in column 58 that is associated with block type BT20 in column 50, server 12 provides a warning indicating the doctor's preference for a perfect attendee instead of a chronic no-show client and indicates that the doctor's preference cannot be bypassed.

In addition, here, server 12 may be programmed to identify appropriate time slots in Dr. Tabor's schedule for scheduling an out-patient appointment for a chronic no-show client. In this regard, block type BT21 in FIG. 5 is specifically earmarked for out-patient appointments for chronic no-show clients. Referring also to FIG. 4, the 4 PM and 5 PM time slots on Friday, July 5 are associated with block type BT21 and therefore would be appropriate for scheduling the appointment specified via window 220 in FIG. 3.

Referring now to FIG. 7, an exemplary warning window 134 that may be provided by server 12 that is consistent with the above referenced example is illustrated. The window includes a text warning 136 that Dr. Tabor does not schedule chronic no-shows during the selected time slot and also indicates that the doctor's preference cannot be bypassed. In addition to the warning, the window includes a notice 138 indicating that there are other times that are appropriate in Dr. Tabor's schedule during which no-show appointments can be scheduled and that are open for scheduling. Below notice 138, two temporally proximate suitable times for scheduling the specified appointment are listed which are collectively identified by numeral 142. In addition, SELECT icons 140 and 144 are provided next to each of the suitable time slots which can be used to select one of the listed time slots for scheduling an appointment.

A CANCEL icon 148 and a ADDITIONAL TIME icon 150 are also provided within window 134. Here, if CANCEL icon 148 is selected, the attempt to schedule the specified appointment is canceled. If the ADDITIONAL TIME icon 150 is selected, server 12 searches other days on Dr. Tabor's schedule to identify other suitable times for scheduling an out-patient for a chronic no-show client. Instructions 146 are provided near the bottom of window 134 that instruct a scheduler on how use the icons thereabove to schedule an appointment, cancel an appointment or access additional appointment times.

Referring once again to FIGS. 1 and 6, after block 88 control loops through blocks 89, 91 and 94 until the scheduler selects one of the input icons provided via window 136. At block 89, if one of the SELECT icons 140, 142 is selected, control passes back to block 92 where the appointment is scheduled in the selected time slot. At block 91, if the ADDITIONAL TIMES icon 150 is selected, control passes to block 87 where server 12 searches the physician schedule database 17 (see FIG. 10 and preferences database 18 for time slots that can accommodate an appointment having the attempted appointment characteristics and provides another window (not illustrated) suggesting the other time slots. After block 87 control passes back up to block 89.

At block 94, where CANCEL icon 148 is selected, control passes from block 94 back up to block 76. If CANCEL icon 148 is not selected, control passes back up to block 88 where the warning window is continually presented.

Referring now to FIG. 8, an exemplary sub-process 96 that may be substituted for a portion of the process of FIG. 6 is illustrated wherein, when a warning is presented indicating physician preferences, the preferences can be bypassed without restriction by a scheduler. To this end, referring also to FIG. 6, if attempted appointment characteristics are different than characteristics associated with a block type corresponding to a specific time slot, control passes from block 86 to block 98. For instance, referring again to FIGS. 4 and 5, if a scheduler attempts to schedule an out-patient appointment for a chronic no-show client during the 5 PM time slot on Thursday July 4 that is associated with a block type BT19, the chronic no-show characteristic will be different than the perfect attendee characteristic specified by matching logic column 54 for block type BT19 and therefore control will pass to block 98.

In this example, at block 98, server 12 presents a warning indicating the physician's preference not to schedule chronic no-shows during the selected time slot and allowing the scheduler, if desired, to bypass the preference. To this end, referring to FIG. 9, an exemplary warning window 40 consistent with the present example is illustrated that includes a text warning 42 indicating physician preference and indicating that the preference may be bypassed along with a BYPASS icon and a CANCEL icon 44 and 46, respectively. Here, the warning 42 indicates physician preferences as well as provides instructions regarding how to use icons 44 and 46 to continue the scheduling process. If icon 44 is selected, the doctor's preference is bypassed and server 12 schedules the specified appointment. If icon 46 is selected, the appointment attempt is canceled.

Referring again to FIGS. 1 and 8, after block 98 control passes to block 90. At block 90 server 12 determines whether or not the scheduler has elected to bypass the physician preferences. Where the scheduler bypasses the preferences, control passes to block 92 in FIG. 6 where server 12 schedules the appointment in the specified time slot. If the scheduler has not elected to bypass the preferences, control passes from block 90 in FIG. 8 back to block 94 in FIG. 6.

Referring now to FIG. 10, a sub-process 110 that may be substituted for a portion of the process 70 in FIG. 6 is illustrated wherein, when a physician's preference warning is provided, server 12 provides input tools allowing a scheduler to enter a password to enable restricted bypassing of the physician's preferences. Referring also to FIGS. 1 and 6, if attempted appointment characteristics are different than block type characteristics for a specified time slot, control passes form block 86 to block 112 in FIG. 10. For example, referring again to FIGS. 4 and 5, if a scheduler attempts to schedule an out-patient appointment for the 4 PM time slot on Tuesday, July 2 where that time slot is associated with block type BT101 and where the client does not have a premium insurance package, the premium insurance characteristic associated with block type BT101 in database 16 will not be met and control passes to block 112. At block 112, consistent with the warning type in column 58 that is associated with block type BT101 in column 50, a warning is provided along with restricted bypass tools via interface 14.

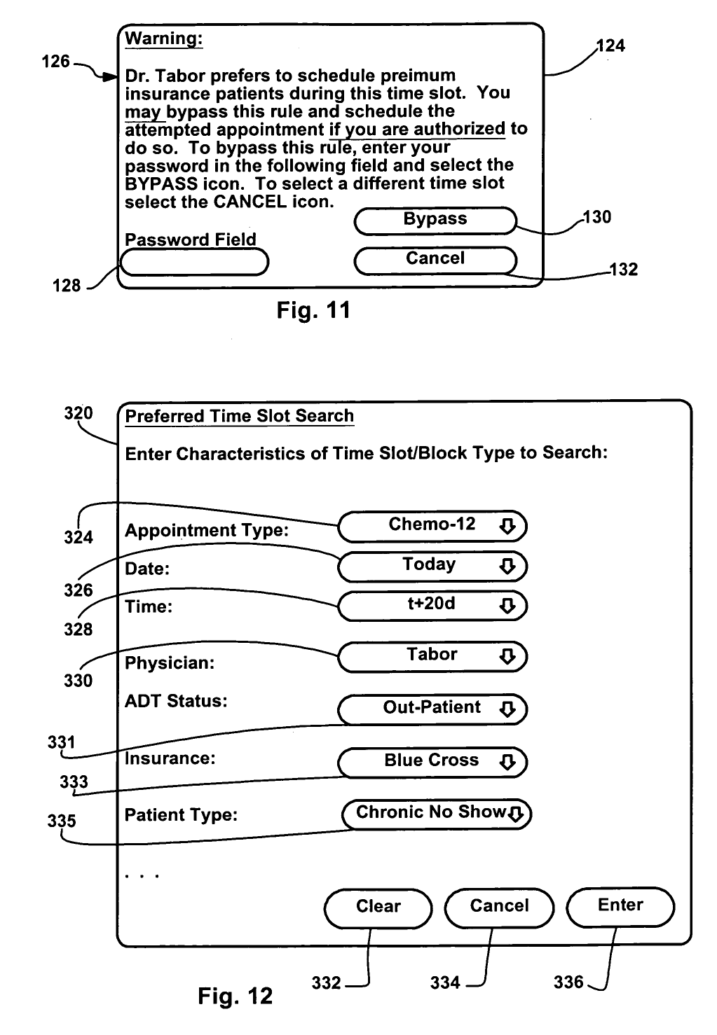

Referring now to FIG. 11, an exemplary warning window 124 consistent with the present example is illustrated. Window 124 includes warning text 126 that indicates that Dr. Tabor prefers to schedule premium insurance patients during the specified time slot and indicating that the doctor's preference can be bypassed if the scheduler is authorized to bypass. Instructions are provided indicating how to bypass the preference and specifically, in the present example, that a password has to be entered into a password field 128 to facilitate a bypass. A BYPASS icon 130 and a CANCEL icon 132 are provided within window 124. After a password is entered into field 128, BYPASS icon 130 can be selected to bypass the preference and facilitate appointment scheduling. If CANCEL icon 132 is selected, the appointment attempt is canceled.

Referring once again to FIGS. 1 and 10, at block 114 server 12 monitors to determine whether or not icon 130 in FIG. 11 has been selected. If icon 130 has not been selected, control passes back to block 94 in FIG. 6. At decision block 114, if BYPASS icon 130 has been selected, control passes to block 116 where server 12 compares the password that was entered in field 128 to passwords assigned to schedulers authorized to bypass physician preferences. Where the passwords are different, an error message is provided at block 118 after which control passes back up to block 112. Where the passwords are identical, control passes back to block 92 in FIG. 6 where server 12 facilitates scheduling of the appointment in the specified time slot.

Referring once again to FIG. 2, in at least some embodiments a TIME SLOT SEARCH icon 25 may be provided as part of a schedule window 22 which may be selected to search for a set of time slots associated with block types having a specific matching logic characteristic set. To this end, in at least some embodiments, when icon 25 is selected, referring to FIG. 12, an exemplary block type search window 320 may be provided via interface 14. Here, search window 320 is similar to the scheduling screen window illustrated in FIG. 3 and, to that end, includes a plurality of fields in which a scheduler can enter various characteristics of an appointment to be scheduled. The exemplary window 320 includes an appointment type field 324, a date field 326, a time field 328, a physician field 330, an ADT status field 331, an insurance field 333 and a patient type field 335.

Here, it is contemplated that date and time fields 326 and 328 can be used to specify a range of dates to search for appropriate time slots for scheduling an appointment. To this end, as illustrated in FIG. 12, a default for the date field 326 may be “today” indicating the current day. Other designations for date field 326 may include a specific date in the future. Time field 328 will include a range typically related to the day specified in date field 326. In FIG. 12, the time designation is “t+20d” where “t” indicates today's date, the “d” indicates a day period and the qualifying number that precedes the “d” indicates a number of days. Thus, the designator “t+20d” indicates today's date plus twenty days and hence the search range specified includes today and the next 20 days. In addition to the specifying fields, window 320 also includes a CLEAR icon 332, a CANCEL icon 334 and a ENTER icon 336 that function in a fashion similar to the like labeled icons in FIG. 3 that are described above.

Referring once again to FIGS. 4 and 5 above and also to FIG. 12, when the exemplary information specified in the fields of FIG. 12 is submitted by a scheduler by selecting ENTER icon 336, server 12 (see again FIG. 1) identifies the 4 PM and 5 PM time slots on Friday, July 5 which are each associated with block type BT21 during which chronic no-show clients may be scheduled. In addition, server 12 may identify other time slots corresponding to days other than those for which information is shown in FIG. 4. Here it will be assumed that the 4 and 5 PM time slots on July 20 also have been associated with block type BT21 and therefore are identified by server 12.

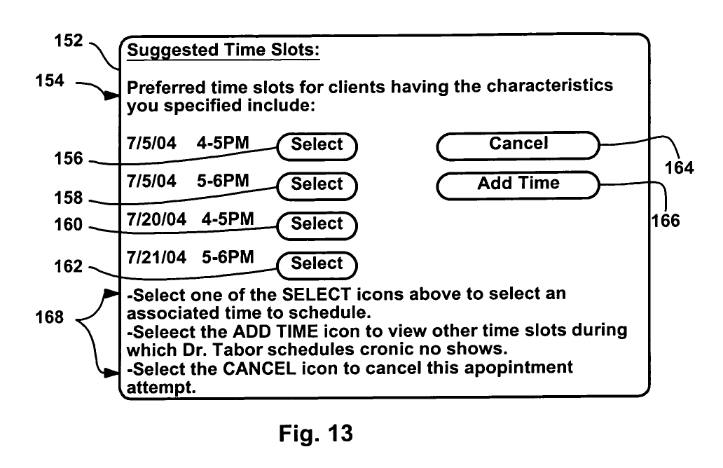

Referring now to FIG. 13, exemplary window 152 for suggesting time slots for an appointment consistent with the specified search characteristics of FIG. 12 is illustrated. Window 152 includes text 154 indicating that preferred time slots have been identified, lists four preferred time slots, each with a different SELECT icon 156, 158, 160 and 162, provides a CANCEL icon 164 and an ADDITIONAL TIME icon 166. Icons 164 and 166 are similar to icons 148 and 150 described above with respect to FIG. 7 and therefore will not be described here in detail. In addition, SELECT icons 156, 158, 160, and 162 are similar to icons 140 and 144 described above with respect to FIG. 7 and therefore will not be described here again. Instructions 168 are provided for selecting any of the icons provided via window 152.

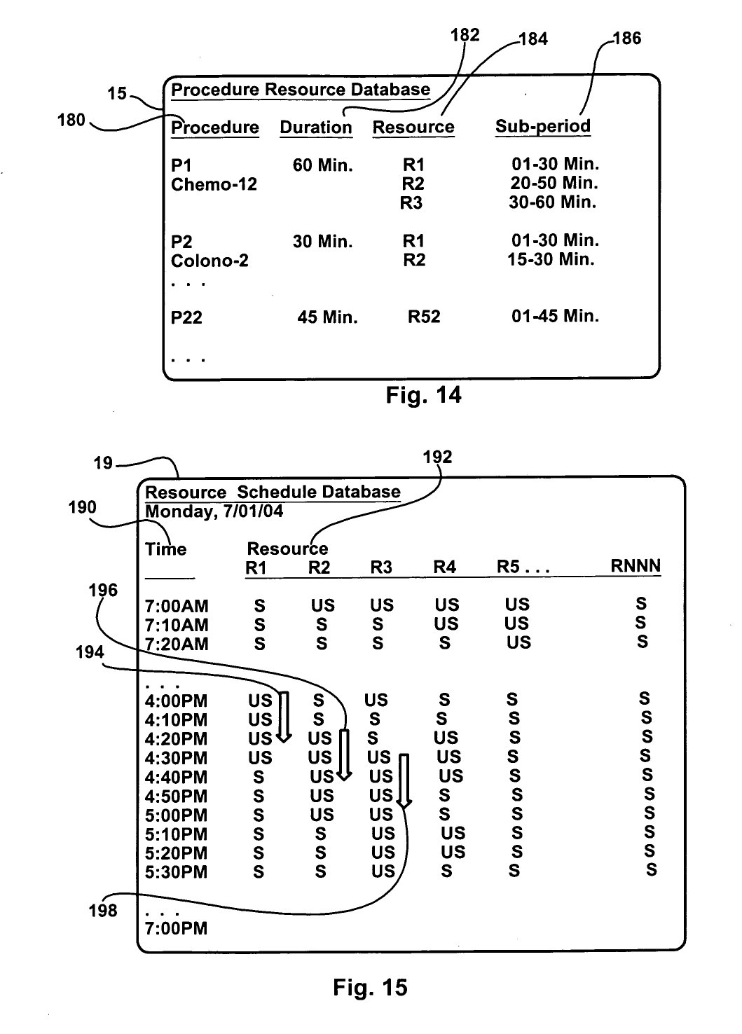

Referring now to FIG. 14, an exemplary procedure resource database 15 is illustrated. Database 15 includes a procedure column 180, a duration column 182, a resource column 184 and a sub-period column 186. Procedure column 180 lists each procedure performed by each physician associated with a medical facility. Exemplary procedures are identified by labels P1, P2, P22, etc. In the present case, it is assumed that procedure P1 is a chemo-12 procedure.

Duration column 182 indicates a duration, in minutes, of each of the procedures in column 180. Thus, for instance, a 60 minute duration is associated with procedure P1, a 30 minute duration is associated with procedure P2, and so on.

Resource column 184 indicates specific medical resources (e.g., specialized systems or equipment) that are required to perform the procedure in column 180. For instance, resources R1, R2, and R3 are each required for procedure P1. As another instance, resources R1 and R2 are required for procedure P2.

Sub-period column 186 indicates a separate sub-period, in minutes, for each one of the resources in column 184. For instances, a sub-period including 1-30 minutes which indicates that the first 30 minutes of the 60 minute duration in column 182 is associated with resource R1 in column 184 for procedure P1. Similarly, resource R2 is required for the 20-50 minute sub-period during procedure P1 and resource R3 is required for the last 30 minutes of the procedure P1.

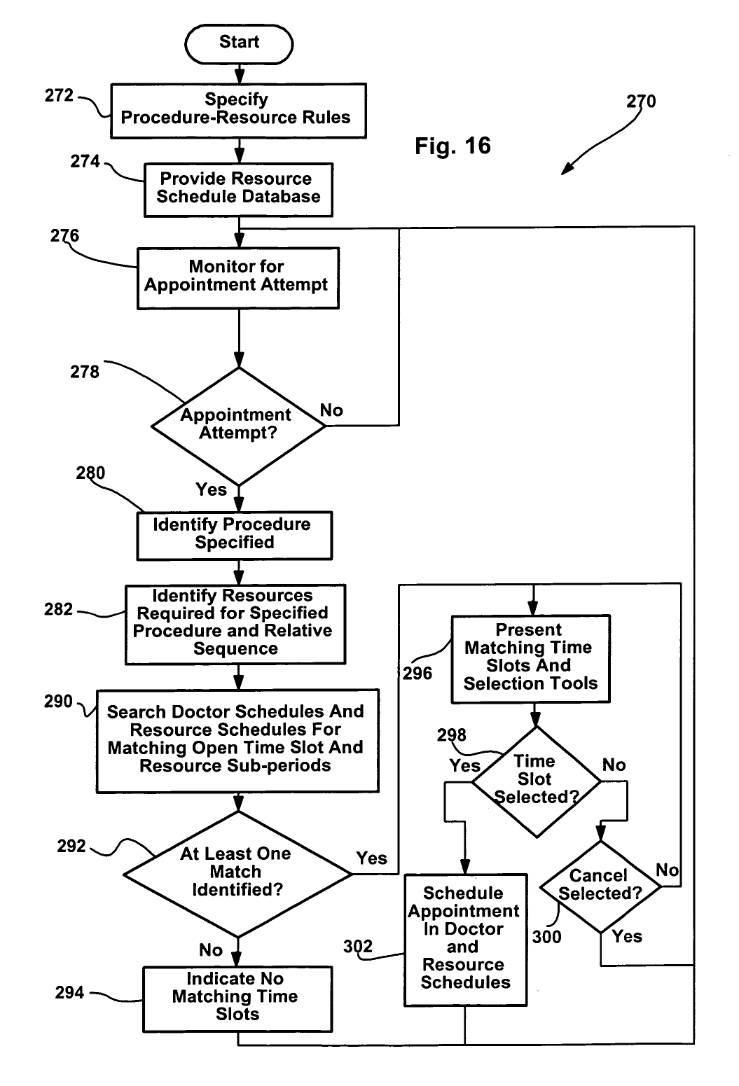

Referring to FIG. 15, an exemplary resource schedule database 19 (see also FIG. 1) is illustrated for a single day, Monday, Jul. 1, 2004. Database 19 includes a time column 190 and a resource section or table 192. Time column 190 divides the working day into 10 minutes increments including 7 AM, 7:10 AM, 7:20 AM, etc. Resource section 192 includes a specific column for each of the specialized systems or medical resources used at an associated medical facility. Thus, for instance, resource columns are designated R1, R2, R3, R4, etc., corresponding to first, second, third, fourth, etc., resources, respectively. A separate scheduled designation “S” or unscheduled designation “US” is provided for each one of the time increments in column 190 for each one of the resources listed in section 192. Thus, schedule 19 indicates that resource R1 is scheduled for each of the 7 AM, 7:10 AM, 7:20 AM, etc., times in column 190 and is unscheduled for the 4 PM. 4:10 PM, 4:20 PM, etc., times in column 190.

Referring now to FIG. 16, an exemplary method 270 for scheduling physician and resource times is illustrated which is consistent with at least some aspects of at least some embodiments of the present invention. At block 272, a procedure resource database like database 15 in FIG. 14 is specified. At block 274, a resource schedule database like database 19 in FIG. 15 is provided that indicates current resource schedules. Referring also to FIG. 1, at block 276, server 12 monitors for an appointment attempt. Here, as in at least one of the examples above, an appointment attempt may be made by selecting ENTER icon 236 in FIG. 3. Until an appointment attempt is made, control loops back from block 278 up to block 276. Once an appointment attempt is made at block 278, control passes to block 280 where server 12 identifies a procedure associated with the appointment type. Here, it is assumed that the appointment type is a chemo-12 type.

Continuing, at block 282, server 12 accesses the procedure resource database 15 (see again FIG. 14) and identifies resources required for the specified procedure as well as the sub-periods of the procedure duration during which each resource is required. Thus, in the present example where the procedure is a chemo-12 procedure, server 12 identifies resources R1, R2 and R3 and associated sub-periods including the first 30 minutes of the procedure, the middle 30 minutes of the procedure and the last 30 minutes of the procedure, respectively.

Next, at block 290, sever 12 searches a doctor's schedule (see again FIG. 2) and a resource schedule (see again FIG. 15) for matching open time slots and resource sub-periods that can be used to accommodate an appointment having the specified characteristics. At block 292, if no match exists, control passes to block 294 where server 12 indicates that no matching time slot exists after which control passes back up to block 276. If, however, at block 292, at least one time slot is identified, control passes to block 296 where server 12 presents the matching time slot or slots and selection tools.

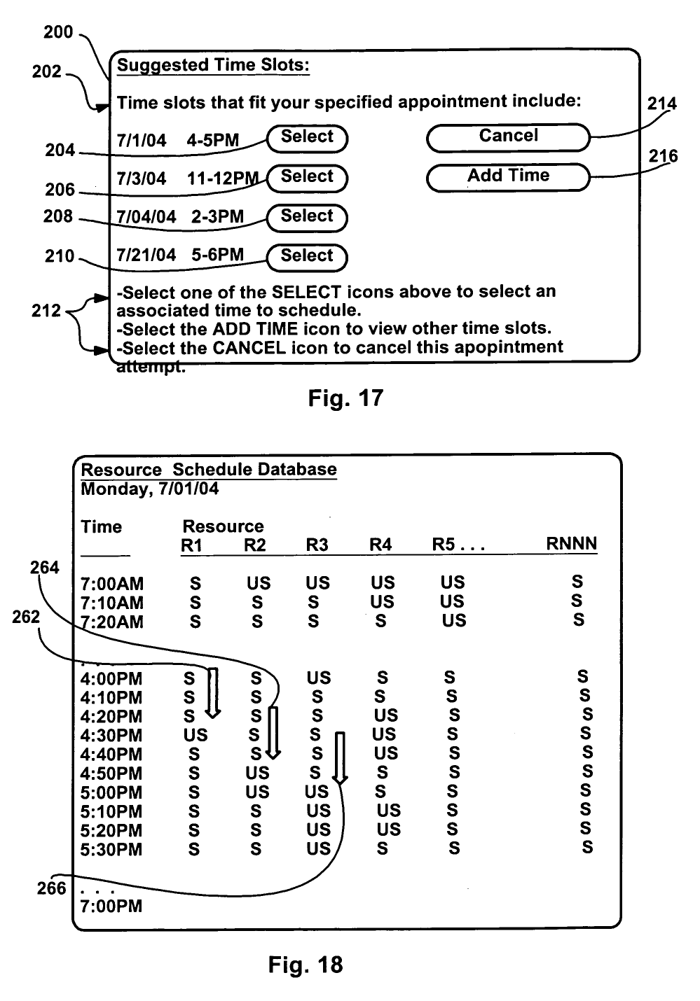

Referring now to FIG. 17, an exemplary window 200 for suggesting time slots is illustrated. An exemplary window 200 includes text 202 that indicates that at least one time slot fits the specified appointment. In addition, window 200 lists the identified time slots that are appropriate for the appointment along with a separate SELECTION icon 204, 206, 208 and 210 for each of the appropriate time slots. Moreover, CANCEL and ADDITIONAL TIME icons 214 and 216 are provided via window 200 that are akin to similarly labeled icons described above with respect to FIG. 7. Instructions 212 are provided near the bottom of window 200 for selecting icons thereabove.

After block 296 in FIG. 16, control passes to block 298. At block 298, server 12 monitors for a time slot selection. If there is no time slot selection, server 12 monitors for selection of CANCEL icon 214 at block 300. If icon 214 is not selected, control loops back through block 296 and 298. If CANCEL icon 214 is selected, control passes from block 300 back up to block 276 where server 12 again monitors for an appointment attempt. Referring again to block 298, if a time slot is selected, control passes from block 298 to block 302 where server 12 schedules an appointment in the doctor and resource schedules.

Referring once again to FIG. 15, on Monday, July 1, there is only one one hour time slot that fits the appointment characteristics specified by the information in FIG. 3 (i.e., a chemo-12 procedure) and by the procedure resource database in FIG. 14 that requires resources R1, R2 and R3 for the first, middle and last 30 minute sub-periods of the procedure duration. To this end, resource R1 is initially unscheduled for the first 30 minutes of the time slot beginning at 4 PM as indicated by arrow 194 adjacent designators in the R1 column, resource R2 is unscheduled from 4:20 PM to 4:50 PM as indicated by the arrow 196 adjacent designators in column R2 and resource R3 is unscheduled from 4:30 PM until 5:00 PM as indicated by arrow 198 adjacent designators in column R3.

Thus, referring again to FIG. 17, one of the appropriate time slots suggested via window 200 and associated with SELECT icon 204 is the 4 to 5 PM time slot on Jul. 1, 2004. If SELECT icon 204 is selected, referring also to FIG. 15, the resource schedule database is updated by replacing the “US” designations adjacent arrows 194, 196 and 198 in FIG. 15 with the “S” designations.

While the invention may be susceptible to various modifications and alternative forms, specific embodiments have been shown by way of example in the drawings and have been described in detail herein. However, it should be understood that the invention is not intended to be limited to the particular forms disclosed. For example, while certain types of warning windows are described above, other types of windows are contemplated. For instance, where preferences cannot be bypassed, server 12 may simply indicate that the preferences cannot be bypassed without suggesting other suitable appointment times. As another instance, where a preference warning is provided with bypass input tools, other more suitable time slots may be identified and suggested via the warning window where the suggested time slots meet attempted appointment characteristics.

In addition, systems that support only one or a sub-set of the different warning types described above are contemplated (e.g., some systems may not support bypass or restricted bypass or no bypass warning types).

Moreover, while some systems may support both the physician preference and resource scheduling concepts to provide advantageous synergies, other systems may only include one or the other of the concepts.

Furthermore, while most of the characteristics described above are client specific, other appointment related characteristics may be used to specify physician preferences. For instance, non-client specific appointment related preferences may include appointment durations, temporal relationships to other appointments (e.g., may want to schedule certain appointment types only after initial imaging, bloodwork, etc., has been completed), etc. In the claims that follow, the phrase “client characteristic” is used to refer to both client and/or appointment related characteristics.

In addition, physician preferences may be specified as combinations of client characteristics (e.g., characteristics related to specific clients), appointment related characteristics (i.e., characteristics of an appointment other than appointment type) and appointment type (e.g., diagnostic, corrective, physical, check-up, etc.)

Thus, the invention is to cover all modifications, equivalents, and alternatives falling within the spirit and scope of the invention as defined by the following appended claims.

To apprise the public of the scope of this invention, the following claims are made:

What is claimed is:

1. A method for use with at least one resource associated with resource clients according to a schedule wherein the schedule indicates association of the resource with specific clients during time slots, the method for scheduling client association of the at least one resource and comprising the steps of:
specifying at least a first set of client characteristics;
identifying at least a first schedule time slot during which resource association should be limited to clients having the first set of characteristics; and
restricting association of clients with the at least a first schedule time slot as a function of client characteristics and the first set of characteristics.

2. The method of claim 1 wherein the client set includes at least a subset of the client's gender, the client's age, payment history, appointment tardiness history, insurance coverage and in-patient out-patient status.

3. The method of claim 1 wherein the step of restricting association of clients further includes the step of, during a scheduling procedure, identifying a client set including characteristics of a specific client for which the at least one resource is to be associated during a time slot and comparing the first set and the identified client set.

4. The method of claim 3 wherein the step of restricting further includes, when the client set and first set are different, restricting association of the client and the at least a first time slot.

5. The method of claim 4 wherein the step of restricting includes preventing association of the client with the at least a first time slot.

6. The method of claim 4 for use with a scheduling interface, the step of restricting including providing an interface, indicating via the interface that association of the client with the at least a first time slot is restricted and allowing at least one interface user having a special status to overrule the restriction and associate the client with the at least a first time slot.

7. The method of claim 4 for use with a scheduling interface, the step of restricting including indicating via the interface that association of the client with the at least a first time slot is restricted and allowing any interface user to associate the client with the at least a first time slot.

8. The method of claim 1 further including the steps of, for each of at least a subset of the schedule time slots, specifying time slot specific sets of client characteristics for restricting client association, the step of restricting association of clients further including restricting association of clients with each of the subset schedule time slots as a function of the client characteristics and the slot specific sets of characteristics.

9. The method of claim 8 further including the step of, during a scheduling procedure, identifying a client set including characteristics of a specific client for which the at least one resource is to be associated during a time slot and comparing at least a subset of the slot specific sets to the identified client set.

10. The method of claim 9 for use with a scheduling interface, the step of restricting including indicating at least a subset of the time slots via the interface that correspond to slot specific characteristic sets that match the identified client set for possible association with the client.

11. The method of claim 1 wherein the step of restricting association includes restricting association in a first way, the method further including the steps of identifying at least a second schedule time slot during which resource association should be limited to clients having the first set of characteristics and restricting in a second way association of clients with the at least a second time slot as a function of client characteristics and the first set of characteristics, the second way of restricting being different than the first way of restricting.

12. The method of claim 11 wherein the first way of restricting is one of prohibiting association, providing an indication of preferred prohibition while allowing association and providing an indication of prohibition while allowing certain personnel to override the prohibition and allow association and the second way of restricting is another of prohibiting association, providing an indication of preferred prohibition while allowing association and providing an indication of prohibition while allowing certain personnel to override the prohibition and allow association.

13. The method of claim 11 further including the step of, during a scheduling procedure, identifying a client set including characteristics of a specific client for which the at least one resource is to be associated during a time slot and comparing the first set and the identified client set.

14. The method of claim 11 further including the steps of identifying at least a third schedule time slot during which resource association should be limited to clients having the first set of characteristics and restricting in a third way association of clients with the at least a third time slot as a function of client characteristics and the first set of characteristics, the third way of restricting being different than the first and second ways of restricting.

15. The method of claim 1 wherein at least some of the time slots are unrestricted such that a client having the first set of characteristics can be associated therewith.

16. The method of claim 15 for use with a scheduling interface wherein the step of restricting association of clients further includes the steps of, during a scheduling procedure, identifying a client set including characteristics of a specific client for which the at least one resource is to be associated during a time slot, identifying time slots that are unrestricted such that a client having the first set of characteristics can be associated therewith and presenting at least a subset of the identified time slots via the interface for association with the patient.

17. The method of claim 1 wherein the step of specifying at least a first set of client characteristics includes specifying at least first and second characteristics wherein the first characteristic is a required characteristic and the second characteristic is a preferred characteristic.

18. The method of claim 17 wherein the step of restricting includes, during a scheduling procedure, identifying a client set including characteristics of a specific client for which the at least one resource is to be associated during a time slot and comparing the first set and the identified client set, when the client set includes the first characteristic and the second characteristic, allowing association of the client and the corresponding time slot, when the client set includes only the first of the two characteristics, restricting association in a first way and when the first characteristic is missing from the first client set, restricting association in a second way that is different than the first way.

19. The method of claim 1 further including the step of identifying a commencement period between a current time and each schedule time slot, the step of restricting association further including restricting association of clients with the at least a first schedule time slot as a function of client characteristics, the first set of characteristics and the commencement period corresponding to the at least a first schedule time slot.

20. The method of claim 1 wherein the step of identifying at least a first schedule time slot during which resource association should be limited to clients having the first set of characteristics includes identifying a plurality of time slots during which resource association should be limited to clients having the first set of characteristics, the step of restricting including, when the client and first set match, scheduling the specific client for association during the one of the identified plurality of time slots.

21. The method of claim 20 wherein the step of scheduling the specific client includes indicating at least a subset of the identified plurality of time slots via the interface and allowing selection of at least one of the indicated time slots via the interface.

22. A method for use with at least one resource associated with resource clients according to a schedule wherein the schedule indicates association of the resource with specific clients during time slots, the method for scheduling client association of the at least one resource and comprising the steps of:
obtaining a client characteristic set including characteristics of a specific client; and
restricting association of the specific client with at least a first schedule time slot as a function of the client characteristics.

23. The method of claim 22 wherein the step of restricting includes specifying a first characteristic set including client characteristics corresponding to a clients that may be associated with at least the first time slot, comparing the client set to the first set, when the first set and client set match, allowing association and when the first set and client set are different, at least limiting association.

24. The method of claim 23 wherein the step of limiting association includes one of prohibiting association, providing an indication of preferred prohibition while allowing association and providing an indication of prohibition while allowing certain personnel to override the prohibition and allow association.

25. A method for use with at least first and second resources required to perform at least one specific procedure during a time slot that includes at least a first sub-period and a second sub-period wherein at least a portion of the second sub-period includes time independent of the first sub-period and the first and second resources are required during the first sub-period and a second sub-period, respectively, the method also for use with a schedule wherein the schedule indicates association of the first and second resources with sub-periods of time slots corresponding to instances of procedures, the method for scheduling first and second resource use and comprising the steps of:
specifying information associated with the at least one specific procedure including required resources and the durations of the first and second sub-periods;
identifying at least a subset of schedule time slots where the first and second resources are unscheduled for first and second sub-periods of each of the subset time slots; and
presenting the identified subset of schedule time slots.

26. The method of claim 25 wherein the step of specifying information includes providing a database that correlates the at least one procedure with resources required for the procedure and sub-periods during which each of the required resources is required.

27. The method of claim 26 wherein the step of providing a database further includes providing a database wherein the order of the sub-periods is also specified for the at least one procedure.

28. The method of claim 25 for use with an interface, the step of specifying information including receiving the specifying information via the interface.

29. The method of claim 25 wherein the step of specifying further includes specifying the order of the first and second sub-periods.

30. The method of claim 29 wherein the second sub-period follows the first sub-period, the method further including specifying at least one of a maximum and a minimum duration of an intermediate period between the first and second sub-periods.

31. The method of claim 30 wherein the step of specifying at least one duration includes specifying each of a maximum and a minimum duration of the intermediate period.

32. The method of claim 25 further including the steps of identifying the durations of intermediate periods between first and second sub-periods for each of the identified subset time slots and distinguishing at least one of the subset time slots from the other subset time slots as a function of the intermediate periods, the step of presenting including presenting the at least one distinguished time slot differently than the other subset time slots.

33. The method of claim 32 wherein the step of distinguishing includes identifying the subset time slot associated with the shortest intermediate period.

34. The method of claim 32 further including the step of, for each subset time slot, identifying an intervening time slot between a current time and the subset time slot, the step of distinguishing at least one of the subset time slots from the other subset time slots including distinguishing the at least one subset time slot from the other subset time slots as a function of the intermediate periods and the intervening periods.

35. A method for use with a plurality of resources required during different sub-periods to perform at least one specific procedure during a time slot, the method also for use with a schedule wherein the schedule indicates association of the resources with sub-periods of the time slots corresponding to instances of the procedure, the method for scheduling use of the plurality of resources and comprising the steps of:
for the at least one specific procedure, providing resource requirement information that specifies required resources and the durations and relative timings of the sub-periods associated with the resources;
identifying at least a subset of schedule time slots during which the required resources are unscheduled for sub-periods of each of the subset time slots specified by the resource requirement information; and
presenting the identified subset of schedule time slots.

36. The method of claim 35 wherein the step of presenting the identified subset time slots includes providing an interface and presenting the identified subset time slots via the interface.

37. The method of claim 36 further including the steps of receiving a selection of one of the presented time slots and associating the resources with sub-periods of the selected time slot for an instance of the at least one procedure.
